(19) United States
(12) Patent Application Publication
(10) Pub. No.: US 2014/0330613 A1
(43) Pub. Date: Nov. 6, 2014

(54) Add-on to the Informatica PowerCenter tool that allows the management of the dependencies and executions of Informatica PowerCenter workflows

(71) Applicant: William James Flood, II, Highlands Ranch, CO (US)

(72) Inventor: William James Flood, II, Highlands Ranch, CO (US)

(21) Appl. No.: 13/887,358

(22) Filed: May 5, 2013

(51) Int. Cl. G06Q 10/06

(52) U.S. Cl. CPC G06Q 10/06316
USPC 705/7.26

(57) ABSTRACT

The add-on provides methods and systems for the management of the dependencies, executions along with notifications of the executions of Informatica PowerCenter workflows. This is an add-on to the Informatica PowerCenter tool that allows the workflow executions to be managed from within the tool by a managing workflow. The add-on is integrated and automatically recognizes and reacts to different events with no code changes needed for existing workflows it will manage. The tool is similar to external generic platform third party scheduling software but this tool is different because it is integrated directly on the Informatica repository database level. It utilizes PowerCenter's existing features and is designed solely for Informatica PowerCenter. Since it is integrated directly in the PowerCenter tool it is easier to use and setup, has better monitoring and workflow execution features then other generic scheduling software.

### CROSS-REFERENCE TO RELATED APPLICATIONS

This application claims the benefit of U.S. provisional patent Application No. 61/651,995, filed May 25, 2012, entitled “An add-on to the Informatica PowerCenter tool that allows the workflows executions to be managed,” which is hereby incorporated by reference.

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM, LISTING COMPACT DISC APPENDIX

Not Applicable

### BACKGROUND OF THE INVENTION

An add-on to the Informatica PowerCenter tool (IPC) that allows the management of the dependencies and executions of IPC workflows.

This add-on works in the field of technology of moving data. The IPC software tool is used to Extract, Transform and Load (ETL) data from one location of data to another location. The add-on is integrated with the IPC tool and controls the workflow's execution which does the ETL process.

The data movement tool of Informatica was popularized when Data Warehouses were becoming more common in business. The continued and changing needs of moving data from one location to another continues to cause additional functionality to be added to the Informatica PowerCenter tool.

While the Informatica PowerCenter is a very capable tool for extracting, transforming and loading data the detailed management of these loads have not been addressed directly in the tool. Generic scheduling tools that schedule work tasks across different technologies can be used to achieve more detailed control of workflows but none have been designed directly for this tool.

### BRIEF SUMMARY OF THE INVENTION

This add-on is integrated into the Informatica PowerCenter tool to control the dependent execution of workflows. The tool is easy to setup because names of Informatica folders and workflows are auto populated into the add-on from data in the Informatica database repository. The dependencies between workflows can be defined through the GUI front end this add-on provides.

The add-on also allows for re-execution and alerts users when workflows fail too many times or run longer than expected. Workflows can be grouped together into a group of workflows (Loads) and be managed as a group. All of these features allow the setting up of workflow dependencies and managing the execution of workflows to be managed by the software.

### BRIEF DESCRIPTION OF THE SEVERAL VIEWS OF THE DRAWING

FIG. 1 is an illustration of a view of the movement of data by an Informatica PowerCenter workflow from one data location to another.

FIG. 2 is an illustration of the view of an end-user interacting with the Microsoft Access front-end and interface on their personal computer which is writing information to the Informatica database repository area.

FIG. 3 is an illustration of the view of the Informatica repository database tables interacting with the add-on's database tables and then communicating with the server with the Informatica software application.

### DETAILED DESCRIPTION OF THE INVENTION

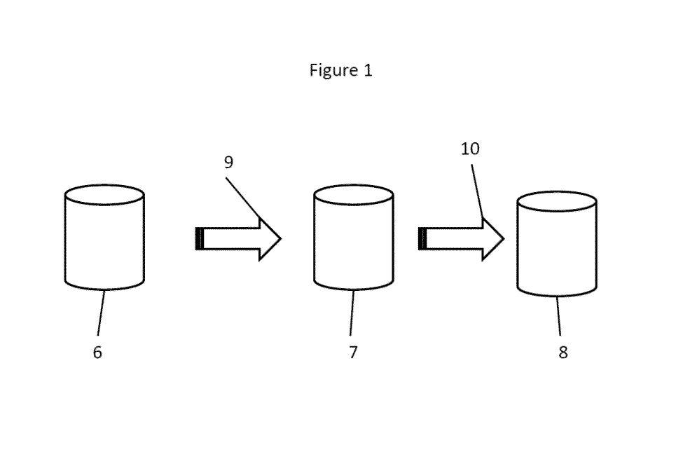

Informatica PowerCenter Standard Edition (IPC) is a tool that moves data from one location to another (ETL). FIG. 1 represents workflow_{—}1 (9) moving data from point A (6) to point B (7). Another workflow_{—}2 (10) will move data from point B (7) to point C (8). A workflow dependency would need to be created to make sure workflow_{—}2 (10) does not execute before the data has been moved by workflow_{—}1 (9) to point B (7). There is no built in feature for that tool to manage the dependent executions of these jobs (workflows). This leaves users forced to implement a number of inflexible and inconsistent techniques to try to manage this, none of them are integrated specifically into the IPC tool. There is no built in alerts for the IPC standard edition when jobs run to long or terminate. Whenever dependencies between workflows change, workflow logic must often be changed as well. There is no way to pause a data load or group workflows into multiple runs without making multiple copies of the code.

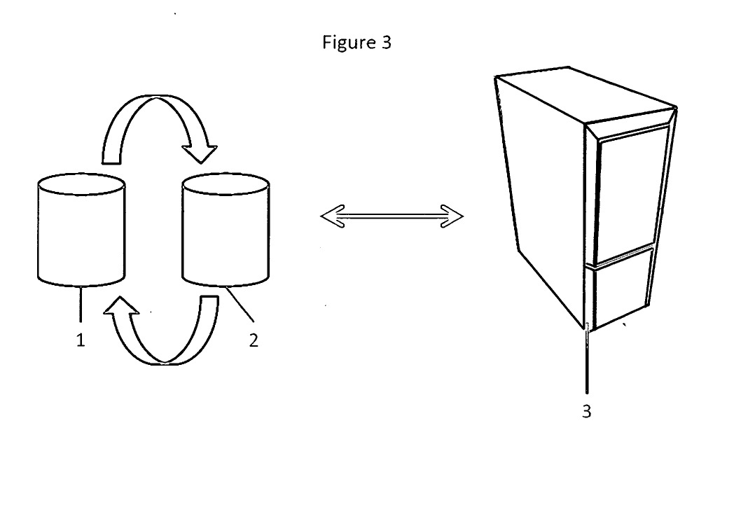

Generic scheduling tools have been developed by third parties that work for all types of systems, but are not designed specifically for IPC. Since they are not specific to IPC, there is extra coding needed to implement it and to try to get the desired behaviors. This add-on is integrated directly into IPC which allows it to automatically recognize and react to different events with no specific coding needed. FIG. 3 represents data in the IPC repository database (1) directly interacting with the add-on's database tables (2). The information is then passed back and forth to the IPC software on the server (3).

The add-on automates and integrates the running of the jobs (workflows) into an add-on made specifically for IPC. This allows for alerts to be sent when workflows run to long, terminate, and fail after multiple attempts are made to run it successfully. The load can be paused causing no new workflows to start and workflow dependencies and predecessors are all easily managed in an easy to use interface. One workflow can be categorized into a “Load” which is a grouping of workflows. This allows the same workflow to be run in multiple loads meaning a copy of the workflow doesn't need to be created. All this is done without ever needing to update the existing workflow code.

The add-on differs from scheduling software that currently exists. The add-on is the only fully integrated scheduling and job (workflow) management tool for the IPC. The full integration allows the tool to have features other scheduling tools don't have. The add-on is integrated to automatically recognize and react to different events with no specific coding needed.

The Version of the Invention Discussed here Includes:

1. A computer running any version of Windows XP or newer

2. A working installation of Informatica PowerCenter 8.6.0 or newer on a Windows or Unix Operating system running on a SQL Server or Oracle database

3. An installation of Microsoft Access 2003 or newer version on each personal computer wanting to use the add-on

4. A computer monitor

5. A mouse or other manually manipulable interface for controlling on-screen cursor activity

6. A computer keyboard

7. The subject computer-readable medium (the “software”)

### Relationship Between the Components:

All computer peripherals (color monitor (4), computer keyboard (6) and mouse or other manually manipulable interface for controlling onscreen cursor activity (5)), along with a computer running any version of Windows XP or newer are connected, the software (7) is installed onto the computer with an installation of Microsoft Access 2003 or newer on each Personal Computer wanting to use the add-on and on a working installation of Informatica PowerCenter 8.6.0 or newer on a Windows or Unix Operating system running on a SQL Server or Oracle database (2). (3). The computer is connected via an ODBC connection to the working installation of Informatica PowerCenter 8.6.0 or newer on a Windows or Unix Operating system running on a SQL Server or Oracle database (2). The user is then able to setup and manage the data loads (workflows) with the subject computer-readable medium (the software) (7) from the computer running any version of Windows XP or newer (1).

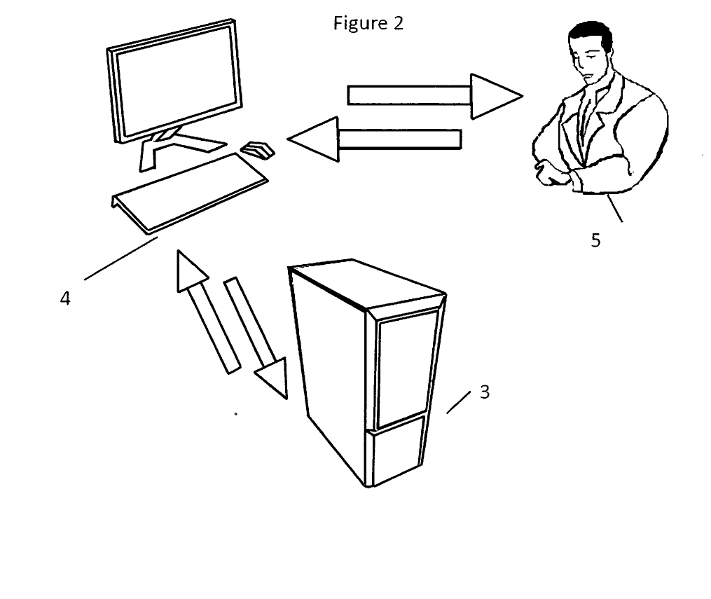

FIG. 2 represents an end-user (5) interacting with front-end application written in Microsoft Access on their Personal Computer (4). The information is passed to the Informatica application and database repository including the add-ons tables (3).

### How the Invention Works

A computer running any version of Windows XP or newer is an Operating System that can run Microsoft Access 2003 or newer and allow an ODBC database connection to be created. The ODBC database connection allows the Microsoft Access software running on a personal computer to communicate to the working installation of Informatica PowerCenter 8.6.0 or newer on a Windows or Unix Operating System running on a SQL Server or Oracle database. The installation of Informatica PowerCenter is where all the data loads and information about the jobs (workflows) are stored. The personal computer acts as the central hub for this activity, taking input from the users and allowing them to interact with the software from the Microsoft Access front end. Once all the setup is complete the user must have IPC workflows created first before they can be setup in the add-on.

### How to Make the Invention

To make this add-on, one must create a Graphical User Interface (GUI) that is able to show all the needed workflows and settings. They would also have to create software that would handle all the complex logic of running, aborting, timing job runs and setting up logic on when to alert users of different scenarios. It would need to complete the required tasks and provide the user with the useful tool described hereabove.

All elements are necessary to have a working system to manage a workflow. Even more load scenarios and user defined settings can be added to make the software more feature rich. Handling different workflow statuses or allowing more automated setup can be added to the GUI tool. The GUI tool could also be written in another technology other then Microsoft Access.

### How to use the Invention:

The user would install the add-on's tables in the Informatica PowerCenter repository database and the GUI front-end on their personal computer. They would then go into the Microsoft Access front-end and group Informatica workflows into different loads. They would go into each workflow individually and setup each workflow's setting. By allowing the user to setup each workflow they can run loads with a new set of alerts and runtime options, allowing for better managed data loads.

Additionally: Logic could be written that would find the setting that most users use. Then those choices could be automatically filled out so a user doesn't need to do any manual setup. This software could also produce some reports that uses would find helpful.

1. A method of managing the dependencies and execution of PowerCenter workflows and notifications by using features available directly in the PowerCenter application facilitated by a managing workflow.

2. The method of claim 1 further comprising: management of the dependencies and executions of power center workflows and notifications by directly joining the add-ons database tables with the Informatica repository database tables.
